(19) United States
(12) Patent Application Publication
(10) Pub. No.: US 2003/0228429 A1
(43) Pub. Date: Dec. 11, 2003

(54) Ink-jet recording medium comprising a microporous layer on a support

(75) Inventors: Marcella Ercoli, Varazze (IT); Alessandro Gunnella, Savona (IT); Danilo Ferraro, Cairo Montenotte (IT)

Correspondence Address: MARK A. LITMAN & ASSOCIATES, York Business Center, Suite 205, 3209 West 76th Street, Edina, MN, 55435, US

(73) Assignee: Ferrania, S.p.A.

(21) Appl. No.: 10/453,429

(22) Filed: Jun. 3, 2003

(30) Foreign Application Priority Data
Jun. 5, 2002 (IT) SV2002A000028

(51) Int. Cl. B32B 3/00

(52) U.S. Cl. 428/32.1; 428/32.28

(57) ABSTRACT

The present invention relates to an ink-jet recording medium having an ink-receiving layer comprising a solution of alumina hydrate, polyvinyl alcohol with saponification degree lower than 90%, boric acid or a borate, and at least a surfactant.

Said solution does not show any coating defects when coated by the slide coater technique, still showing good properties, such as stable viscosity during time, instant drying, good image quality and water resistance.

### BACKGROUND OF THE INVENTION

1. Field of the Invention

The present invention relates to an ink-jet recording medium comprising a microporous layer coated on a support.

2. Background of the Art

Ink-jet recording sheets having a porous layer coated onto a substrate, wherein the porous layer consists essentially of a pigment, such as, alumina hydrate, and of a binder, such as polyvinyl alcohol, are well known in the art. For example, U.S. Pat. No. 5,104,730 discloses a recording sheet comprising a substrate and a porous layer of ink absorbent formed thereon, wherein the porous layer consists essentially of pseudo-boehmite and a binder, preferably a polyvinyl alcohol. In addition, U.S. Pat. No. 5,635,291 discloses a recording medium comprising a base material and an ink-receiving layer which comprises a pigment and a binder provided on the base material, wherein the ink-receiving layer has an average pore radius of 20 to 200 angstrom and a half breadth of pore radius distribution of 20 to 150 angstrom. The latter patent pefines the term “half breadth of pore radius distribution” as used herein means a breadth of pore radius which is a magnitude half of the magnitude of the average pore radius. It is asserted that if the average pore radius is larger than the upper limit of the above range, the resulting recording medium is deteriorated in the adsorption and fixing of a dye in an ink, and so bleeding tends to occur on images. If the average pore radius is smaller than the lower limit of the above range, the resulting recording medium is deteriorated in ink absorptiveness, and so beading tends to occur. On the other hand, if the half breadth is outside of this range, the resulting recording medium is deteriorated in the adsorption of a dye or a solvent in an ink.

The addition of boric acid to ink-jet recording sheets containing alumina hydrate and polyvinyl alcohol is also known in the art. For example, U.S. Pat. No. 5,523,149 discloses a recording sheet comprising a substrate and a alumina hydrate layer formed thereon. The alumina hydrate layer contains a polyvinyl alcohol in an amount of from 5 to 50 weight % relative to the alumina hydrate, and boric acid or a borate in an amount of from 0.1 to 10 weight % as calculated as H₃BO₃ relative to the polyvinyl alcohol, to reduce the formation of microcracks during the drying of the layer. Japanese Patent Application N. 07-076,161 discloses a base material coated with an alumina sol coating liquid for forming an alumina hydrate porous layer. The alumina sol contains alumina hydrate and polyvinyl alcohol, and additionally 0.1-10 wt. % of boric acid or borate based on H₃BO₃ conversion relative to the weight of the polyvinyl alcohol to restrain generation of fine cracks which may occur at coating and drying, in manufacturing an alumina coat layer having excellent ink-absorbing property. Japanese Patent Application No. 10-044,584 discloses an alumina hydrate porous layer formed by coating a base material with an alumina sol coating solution containing alumina hydrate and polyvinyl alcohol, containing 0.1-10 weight % of boric acid or borate in terms of H₃BO₃ with respect to polyvinyl alcohol. The material further contains an organic solvent with surface tension of 40 dyne/cm or less in an amount of 0.05-10% by weight of the total alumina coating solution to enhance coating stability and to suppress the generation of fine cracks at the time of the drying of coating in the production of an alumina coating layer that ios good in ink absorbability of a recording sheet based on a transparent plastic sheet or the like. Japanese Patent Application No. 10-044,585 describes an alumina coating liquid containing hydrate alumina, polyvinyl alcohol, boric acid and a surfactant. The boric acid amount ranges from 0.1 to 10% by weight with respect to polyvinyl alcohol and the surfactant amount ranges from 0.01 to 10% by weight with respect to the entire coating liquid. The surfactant acts as leveling agent of the coated dispersion and is supposed to reduce itself the formation of microcracks. Japanese Patent Application No. 11-291,621 solves the problem of superior crack preventiveness and absorptiveness of a recording sheet by providing a porous ink absorption layer containing boehmite and polyvinyl alcohol on the surface of a base material treated by one or more kind of boric acid and borate and a surface treating agent. Such boric acid or the like is present in 0.5-1.5 g/m² per unit area of the base material in terms of H₃BO₃.

The polyvinylalcohol disclosed in all the applications described above has a saponification degree higher than 90%. Coating solutions of alumina hydrate, boric acid and polyvinyl alcohol having the described saponification degree higher than 90% have the disadvantage that their viscosity can considerably increase in a quite short period of time, with the consequence that the coating solutions can not be completely coated on a support base material before they reach a too high level of viscosity. Japanese Patent Application No. 2000-239,578 solves this problem by disclosing a substrate coated with a coating solution containing alumina hydrate and a polyvinyl alcohol having a saponification degree lower than 90%; the substrate is also coated with further boric acid in the total amount of 0.1-50 weight % based on the polyvinyl alcohol and expressed in terms of H₃BO₃. The coated liquid is stable with time, reducing the tendency to increase its viscosity and it is then dried at a temperature lower than 120° C. to form a porous layer with good ink absorptivity.

However, the coating solution disclosed in Japanese Patent Application No. 2000-239,578 has been found by Applicants to suffer from a previously unrecognized problem that, when coated on a support base material by the slide coating technique or by the knife coating technique, a non-uniform coating is obtained, with the result that coating defects, such as rivulets, clots or lines and thickness variation can be observed. This detracts from the final image quality.

Hence, there is still the need to obtain an ink-jet recording sheet comprising a microporous layer consisting essentially of a solution of alumina hydrate, polyvinyl alcohol having a saponification degree lower than 90% and boric acid coated on a support base material which does not show any coating defects when coated by the slide coater technique. The recording sheet should still show good properties, such as stable viscosity during time, instant drying, good image quality and water resistance.

### SUMMARY OF THE INVENTION

The present invention relates to an ink-jet recording medium having an ink-receiving layer comprising a solution of alumina hydrate, polyvinyl alcohol with saponification degree lower than 90%, boric acid or a borate, and at least a surfactant.

This solution does not show any coating defects when coated by the slide coater technique, and still shows good properties, such as stable viscosity during time, instant drying, good image quality and water resistance.

### DETAILED DESCRIPTION OF THE INVENTION

The alumina hydrate may be represented by the formula Al₂O₃.nH₂O; specifically, it may, by way of non-limiting example, be gibbsite, bayerite, nordostrandite, boehmite, diaspore or pseudoboehmite. Alumina hydrate, and in particular boehmite or pseudoboehmite, (wherein n is from 1.0 to 2.0) is preferably used in the recording medium of the present invention.

Alumina hydrate, as described for example in EP patent application No. 636,489, can be produced by any conventional method such as the hydrolysis of aluminum alkoxide or sodium aluminate. Rocek, et al. [Collect Czech. Chem. Commun., Vol. 56, 1253-1262 (1991)] have reported that the pore structure of aluminum hydroxide is affected by deposition temperature, pH of the solution, aging time and surfactants used. [WOULD THESE SURFACTANTS BE CARRIED FORTH IN PRIOR ART COMPOSITIONS, AND IS THE PRIOR ART OF ALUMINUM HYDRATE AND BORIC ACID FREE OF SURFACTANTS? For example, see the disclosure of U.S. Pat. Nos. 5,635,291 and 5,962,124 where it is stated:

“The alumina hydrate and binder may optionally contain dispersants for the alumina hydrate, viscosity modifiers, pH adjustors, lubricants, flowability modifiers, surfactants, antifoaming agents, water-proofings, foam suppressors, releasing agents, foaming agents, penetrants, coloring dyes, optical whitening agents, ultraviolet absorbents, antioxidants, antiseptics and mildewproofing agents.”]

The shape of the alumina hydrate used in the present invention can be in the form of a needle or in the form of a flat plate (as described in the literature by Rocek J., et al., Applied Catalysis, Vol. 74, 29-36 (1991), the latter being particularly preferred for the reasons that better dispersibility can be obtained and because the orientation of particles of the alumina hydrate in the form of a flat plate becomes random when forming an ink-receiving layer, so that the range of the pore radius distribution widens. The average particle diameter of the alumina hydrate is preferably in the range from 10 to 200 nm, preferably from 10 to 100 nm.

The BET [DEFINE “BET”] specific surface area of the alumina hydrate was calculated in accordance with the method described in Brunauer, et al., J. Am. Chem. Soc., Vol. 60, 309 (1938). The BET specific surface areas may preferably be within a range of from 70 to 300 m²/g, more preferably in the range from 100 to 250 m²/g. If the BET specific surface area is greater than the upper limit of the above range, a dye in an ink cannot be fully adsorbed and fixed. On the other hand, specific surface areas smaller than the lower limit of the above range result in failures to apply the pigment with good dispersibility and hence to control the pore radius distribution.

The pore radius and pore volume of the alumina hydrate were calculated in accordance with the method described in Barrett, et al., J. Am. Chem. Soc., Vol. 73, 373 (1951). The average pore radius of the alumina hydrate preferably is in the range of from 2 to 100 nanometers, more preferably from about 5 to about 50 nanometers, most preferably from 5 to 30 nm. According to the present invention, particularly useful alumina hydrate has a pore radius maximum within a range of from 9 to 12 nm in a pore radius distribution of the fine powder material and a total volume of pores having radii not exceeding 5 nm is not more than 10% of a volume of all pores of the fine powder material.

The pore volume of the alumina hydrate is preferably within a range of from 0.3 to 1.0 ml/g, more preferably from 0.7 to 1.0 ml/g. If the pore volume of the alumina hydrate is greater than the upper limit of the above range, cracking and dusting may occur on the ink-receiving layer. If the pore volume is smaller than the lower limit of the above range, the resulting recording medium is deteriorated in ink absorption capability.

In the present invention, the dry content of the alumina hydrate in the coating solution is preferably from 10 to 30 weight %, more preferably from 15 and 25 weight %. The ink-receiving layer preferably comprises from 10 to 40 g/m², more preferably from 15 to 35 g/m² of alumina hydrate. The solvent is preferably water.

The polyvinyl alcohol shows a saponification degree lower than 90%. The saponification-degree is defined by-the formula (A×100)/B, wherein A is the number of free hydroxyl groups in the polyvinyl alcohol and B is the total number of ester groups capable of saponification and of free hydroxyl groups in the polyvinyl alcohol.

A saponification degree equal to or lower than 90% means that a partial saponification degree occurred, compared with the almost completely saponification when such value is around 98-100%.

Preferably, the polyvinyl alcohol has a polymerisation degree equal to or lower than 1500.

Polyvinyl alcohol having a saponification degree higher than 90% and polymerisation degree more than 1500 can not be used in the present invention because it can interact with alumina hydrate, giving a solution with a viscosity which tends to change very rapidly, providing a difficult handling and increasing the possibility of having coating defects.

The dry content of polyvinyl alcohol in the coating solution is preferably in the range from 0.5 to 5 by weight %, more preferably from 1 to 3 by weight %. The ink-receiving layer preferably comprises from 1 to 5 g/m², more preferably from 2 to 4 g/m² of polyvinyl alcohol. If the amount of the binder is less than the above range, the mechanical strength of the alumina hydrate layer tends to be inadequate. On the other hand, if it exceeds the above range, ink-absorptivity of the alumina hydrate layer tends to be impaired.

The ink-receiving layer of the recording medium of the present invention also contains boric acid or a borate. The term “Boric Acid” (with initial capital letters) as used in the practice of the present invention includes not only orthoboric acid but also metaboric acid and hypoboric acid. As the borate, any soluble salt of these Boric Acids are preferably employed. Specifically, Na₂B₄O₇.10H₂O, NaBO₂.4H₂O, K₂B₄O₇.5H₂O, KBO₂, NH₄B₄O₉.3H₂O and NH₄BO₂ may, for example, be mentioned.

The dry amount of Boric Acid or a borate used in the coating solution is generally from 5 to 50 weight %, preferably from 10 to 30 weight %, as calculated as the relative weight of H₃BO₃ relative to the polyvinyl alcohol. The ink-receiving layer preferably comprises from 0.05 to 5 g/m², more preferably from 0.1 to 1 g/m² of Boric Acid or borate. If the content as calculated as H₃BO₃ is less than 5 weight % relative to the polyvinyl alcohol no adequate effect of the present invention tends to be obtained, and it tends to be difficult to prevent formation of fine cracks during the drying operation or to increase the absorptivity. On the other hand, if the content calculated as H₃BO₃ exceeds 50 weight % relative to the polyvinyl alcohol, the change with time of the viscosity of the coating solution tends to substantial, and the coating stability tends to poor.

Moreover, the ink-receiving layer of the recording medium of the present invention is characterized by the presence of at least a surfactant. Preferred examples of surfactants include amphoteric surfactants, cationic surfactants, and non-ionic surfactants.

Non-limiting examples of cationic surfactants include 2-vinylpyridine derivatives and poly-4-vinylpyridine derivatives. Non-limiting examples of amphoteric surfactants include lauryl dimethyl aminoacetic acid betaine, 2-alkyl-N-carboxymethyl-N-hydroxyethyl imidazolinium betaine, propyldimethylaminoacetic acid betaine, polyoctylpolyaminoethyl glycine, and imidazoline derivatives. Non-limiting examples of non-ionic surfactants include non-ionic fluorinated surfactants and non-ionic hydrocarbon surfactants. Non-limiting examples of non-ionic hydrocarbon surfactants include ethers, such as polyoxyethylene nonyl phenyl ethers, polyoxyethylene octyl phenyl ethers, polyoxyethylene dodecyl phenyl ethers, polyoxyethylene alkyl allyl ethers, polyoxyethylene oleyl ethers, polyoxyethylene lauryl ethers, polyoxyethylene alkyl ethers, polyoxyalkylene alkyl ethers; esters, such as polyoxyethylene oleate, polyoxyethylene distearate, sorbitan laurate, sorbitan monostearate, sorbitan monooleate, sorbitan sesquioleate, polyoxyethylene monooleate, and polyoxyethylene stearate; and glycol surfactants. Specific non-limiting examples of non-ionic surfactants include octylphenoxy polyethoxy ethanols, such as Triton™ X-100, X-114, and X-405, available from Union Carbide Co., Danbury, Conn.; acetylenic diols such as 2,4,7,9-tetramethyl-5-decyl-4,7-diol and the like, such as Surfynol™ GA and Surfynol™ CT-136, available from Air Products & Chemicals Co., Allentown, Pa., trimethyl nonylpolyethylene-glycol ethers, such as Tergitol™ TMN-10 (containing 10 oxyethylene units, believed to be of formula C₁₂H₂5O(C₂H₄O)5H), available from Union Carbide Co., Danbury, Conn.; non-ionic esters of ethylene oxide, such as Merpol™ SH (believed to be of formula CH₃(CH₂)₁₂(OC₂H₄)₈OH), available from E.I. Du Pont de Nemours & Co., Wilmington, Del.; non-ionic esters of ethylene oxide and propylene oxide, such as Merpol™ LFH (believed to be of formula CH₃(CH₂)ₙ(OC₂H₄)₈(OC₃H₆)₈OH, where n is an integer from about 12 to about 16), available from E.I. Du Pont de Nemours & Co., Wilmington, Del., and the like, as well as mixtures thereof. Non-limiting examples of non-ionic fluorinated surfactants include linear perfluorinated polyethoxylated alcohols (e.g., Zonyl™ FSN, Zonyl™ FSN-100, Zonyl™ FSO, and Zonyl™ FSO-100 available from DuPont Specialty Chemicals, Wilmington, Del.), fluorinated alkyl polyoxyethylene ethanols (e.g., Fluorad™ FC-170C available from 3M, St. Paul, Minn.), fluorinated alkyl alkoxylates (e.g., Fluorad™ FC-171 available from 3M, St. Paul, Minn.), fluorinated alkyl esters (e.g., Fluorad™ FC-430, FC-431, and FC-740 available from 3M, St. Paul, Minn.) and fluorine-substituted alkyl esters and perfluoroalkyl carboxylates (for example, the F-tergentseries™ manufactured by Neos Co., Ltd., the Lodyneseries™ manufactured by Ciba-Geigy, the Monflorseries™ manufactured by ICI, the Surfluonseries™ manufactured by Asahi Glass Co., Ltd., and the Unidyneseries™ manufactured by Daikin-Industries, Ltd.). Preferred nonionic fluorocarbon surfactants include Zonyl™ FSO, Fluorad™ FC-170C, and Fluorad™ FC-171.

The above mentioned surfactants are added to the coating solution in an amount from 0.1 to 10 g/l, preferably from 0.5 to 5 g/l. The ink-receiving layer comprises from 0.01 and 1 g/m² of said surfactants, preferably from 0.05 and 5 g/m².

The ink-receiving layer is formed by applying a solution comprising alumina hydrate, polyvinyl alcohol, boric acid or a borate, and a surfactant onto a base material by means of a coater and then drying the base material.

In addition, a dispersant, a thickening agent, a pH adjustor, a lubricant, a fluidity modifier, a surface activator, an anti-foaming agent, waterproof agent, a mold-releasing agent, a fluorescent whitening agent, an ultraviolet absorbing agent, an antioxidant, etc. can be added to a coating liquid for forming an ink-receiving layer so far as the effect of the present invention is not impaired. Said additives can be added in an amount in the range between 0 and 10% by weight related to the total solid content of the ink-receiving layer.

The support used in the ink jet recording sheet of the invention includes any conventional support for ink jet recording sheet. As a support used in the invention, a transparent or opaque support can be used according to the final use of the ink jet recording sheet. A conventional support can be used as the transparent support, which includes a film or plate of polymeric material such as polyester resins, cellulose acetate resins, acryl resins, polycarbonate resins, polyvinyl chloride resins, poly(vinylacetals), polyethers, polysulfonamides, polyamide resins, polyimide resins, cellophane or celluloid and a glass plate. The thickness of the transparent support is preferably from 10 to 200 mm. As the opaque support, any conventional one such as paper, coat paper, synthetic paper, resin-covered paper, pigment-containing opaque film or foaming film can be used in the invention. When the resin-coated paper is used as the base material, the recording medium according to the present invention can be provided as a recording medium having the same feeling to the touch, stiffness and texture as those of a usual photoprint. Further, the recording medium according to the present invention becomes very close to the usual photoprint because its ink-receiving layer has high surface gloss.

The base material may be subjected to a surface treatment such as a corona discharge treatment for improving its adhesiveness to the ink-receiving layer, or provided with an adhesion improving layer as an under coat. Further, a curl-preventing layer such as a resin layer or a pigment layer may be provided on the back surface of the base material or at a desired position thereof to prevent curling.

As a coating process, a blade coating system, air-knife coating system, roll coating system, brush coating system, gravure coating system, bar coating, extrusion system, slot coating, slide coater system, curtain coating system, or the like may be used. The extrusion system and slide coater system are particularly preferred to obtain by one pass a thick coating of proper and uniform thickness. In particular, a slide coater, as described, for example, in U.S. Pat. No. 2,761,419, is a multilayer die composed of a pack of elements, where distribution cavities are formed between each pair of elements. Coating liquids are laterally or centrally fed in the distribution cavities and uniformly spread through a slot, at which end they flow down an inclined plane, stacking in a multilayer stack. At the end of the slide, at a short distance from the edge (about 100-500 microns), the liquid meets and coats the moving web.

The viscosity of the resulting solution is suitable for the use of a slide coater system where the coating solution is run onto a base material (plastic film or paper) in a laminar form. Then, the solution can be dried at a temperature lower than 60° C., preferably lower than 50° C., giving at the end a thick layer with a uniform surface.

The following non-limiting examples will describe in particular the advantages of the present invention over the prior art. These examples are intended to be instructive of the generic scope of the invention and are not be taken as defioning absolute limits in the practice of the invention.

### EXAMPLES

Sample 1 (comparison). A coating solution was obtained by mixing 480 g of a solution at 33% by weight in water of Disperal™ HP14 (an alumina hydrate manufactured by Condea Gmbh, Hamburg, Germany) and 124 g of a solution in water at 15% by weight of Airvol™ 325 (a polyvinyl alcohol manufactured by Air Products, Allentown, Pa., having a saponification degree of 98%, and a polymerization degree of 1500). (DOES THE PVA COME WITH A SURFACTANT PRESENT IN THE MATERIAL? The obtained solution has been warmed to 40° C.; after that, 124 g of a solution in water of boric acid at 3% by weight has been added.

Sample 2 (comparison) has been obtained with the same procedure of sample 1, but the Airvol™ 325 polyvinyl alcohol has been replaced by Airvol™ 523 (a polyvinyl alcohol manufactured by Air Products, Allentown, Pa., having a saponification degree of 88%, and a polymerization degree of 1500).

Sample 3 (comparison) has been obtained with the same procedure of sample 1, with the addition of 8 g at 9.73% in water of Zonyl™ FSN-100 (a non-ionic fluorinated surfactant manufactured by DuPont Specialty Chemicals, Wilmington, Del.).

Sample 4 (invention) has been obtained with the same procedure of sample 2, with the addition of 8 g at 9.73% in water of the same non-ionic fluorinated surfactant used in sample 3.

Sample 5 (invention) has been obtained with the same procedure of sample 2, with the addition of 20 g of a solution of 4% in water of Triton™ X-100 (a non-ionic surfactant available from Union Carbide Co., Danbury, Conn).

The viscosity of samples 1 to 5 has been measured by a Epprecht™ viscosimeter at a temperature of 40° C. and a shear rate of 40.85 sec⁻¹. The viscosity values, measured in milliPascal per second (mPa.s) are shown in Table 1.

TABLE 1

| | PVA | PVA | | | Viscosity | Viscosity | Viscosity |
|---|---|---|---|---|---|---|---|
| | saponific. | polymer. | | Fresh | after | after | after |
| | Degree | Degree | Surfactant | viscosity | 5 minutes | 1 hour | 2 hours |
| Sample 1 | 98% | >1500 | no | 38.3 | jellied | jellied | jellied |
| (comparison) | | | | | | | |
| Sample 2 | 88% | 1000-1500 | no | 33.8 | 33.9 | 34.1 | 34.8 |
| (comparison) | | | | | | | |
| Sample 3 | 98% | >1500 | yes | 38.4 | 62.4 | 110.4 | jellied |
| (comparison) | | | | | | | |
| Sample 4 | 88% | 1000-1500 | yes | 33.6 | 33.6 | 33.6 | 38.4 |
| (invention) | | | | | | | |
| Sample 5 | 88% | 1000-1500 | yes | 35.2 | 35.2 | 35.2 | 38.6 |
| (invention) | | | | | | | |

Table 1 shows that the viscosity of comparison sample 1, containing a polyvinyl alcohol having a high saponification degree and not containing any kind of surfactant, was growing so quickly that after few minutes the solution has been completely jellied, rendering impossible its coating onto a substrate. The viscosity of comparison sample 3, containing a polyvinyl alcohol with the same high saponification degree of sample 1 and a surfactant, increases sufficiently to render the solution completely jellied after two hours. On the contrary, the viscosity of comparison sample 2 (containing a polyvinyl alcohol having saponification degree of 88% and no surfactants) and invention samples 4 and 5 (both containing a polyvinyl alcohol with a saponification degree of 88% and different kind of surfactants), have stable viscosity values during time.

Comparison sample 2 has been coated on a polyethylene terephthalate substrate by means of a knife coater, a coating method in which the liquid is fed in excess on the moving web, forming a pool; then, it is metered through a uniform gap formed by the rigidly supported web and a knife.

Alternatively, comparison sample 2 has been fed by means of a slide coater on a polyethylene terephthalate substrate at speed of 30 meters per minute or at a speed of 5 meters per minute in order to obtain a coverage weight of 30 g/m². At the same time, invention samples 4 and 5 have been fed in the same way by a slide coater and then cooled at a temperature lower than 15° C. and dried at a temperature lower than 50° C.

Table 2 shows the results in terms of coating defects: “rivulets” are defects occurring when the liquid breaks in down web lines, separated by dry lanes; “clots” are defects caused by coagulated particles in the liquid, making a deformation of the coated layer; “lines” are down web defects caused by a clot, a foreign particle, or a build-up on the coater edge, that make an irregularity in the liquid meniscus in the die; “thickness variations” along the coating occur particularly in the knife coater, that, being a not premetered process, is sensitive to even small variations of the liquid, that turns in a not consistent thickness of the coating layer.

Table 2

| | PVA | | | | | | |
|---|---|---|---|---|---|---|---|
| | saponific. | | Coating | | | | Thickness |
| | Degree | Surfactant | technique | Rivulets | Clots | Lines | variation |
| Sample 2 | 88% | no | Knife | good | bad | bad | bad |
| (comparison) | | | coater | | | | |
| Sample 2 | 88% | no | Slide | bad | bad | bad | bad |
| (comparison) | | | Coater | | | | |
| Sample 4 | 88% | yes | Slide | very good | very good | good | very good |
| (invention) | | | Coater | | | | |
| Sample 5 | 88% | yes | Slide | very good | very good | good | very good |
| (invention) | | | Coater | | | | |

Table 2 shows that comparison sample 2, not containing any kind of surfactant, showed, in terms of rivulets coating defects, good results when coated by using a knife coater, but bad results when coated by a slide coater technique. At the same time, comparison sample 2 showed bad results in terms of clots coating defects, line coating defects and thickness variation, when coated by either knife coater or slide coater techniques.

On the contrary, in samples 4 and 5 of the present invention, both containing a surfactant, the liquid film forming on the slide coater was very uniform and the coating quality of the layer was good, without any of the coating defects showed by comparison sample 2. The printing tests performed with Epson 980 and HP 870cx printers on the obtained film showed instant drying time, water resistance, high color density and high image resolution.

1. An ink-jet recording medium having an ink-receiving layer comprising a solution of alumina hydrate, polyvinyl alcohol with a saponification degree lower than 90%, boric acid or a borate, and at least a surfactant.

2. An ink-jet recording medium according to claim 1, wherein the alumina hydrate has a boehmite or pseudo-boehmite structure of formula Al₂O₃.nH₂O, wherein n is a number from 1.0 to 2.0.

3. An ink-jet recording medium according to claim 1, wherein the average particle diameter of the alumina hydrate is in the range from 10 to 200 nm.

4. An ink-jet recording medium according to claim 1, wherein the average particle diameter of the alumina hydrate is in the range from 10 to 100 nm.

5. An ink-jet recording medium according to claim 1, wherein the average pore radius of the alumina hydrate is in the range of from 2 to 100 nanometers.

6. An ink-jet recording medium according to claim 1, wherein the average pore radius of the alumina hydrate is in the range from 5 to about 50 nanometers.

7. An ink-jet recording medium according to claim 1, wherein the alumina hydrate has a pore radius maximum within a range of from 9 to 12 nm in a pore radius distribution of the fine powder material and a total volume of pores having radii not exceeding 5 nm is not more than 10% of a volume of all pores of the fine powder material.

8. An ink-jet recording medium according to claim 1, wherein the polymerization degree of the polyvinyl alcohol is lower than 1500.

9. An ink-jet recording medium according to claim 1, wherein the dry content of the alumina hydrate in the solution is from 10 to 30 weight %.

10. An ink-jet recording medium according to claim 1, wherein the dry content of the polyvinyl alcohol in the solution is from 0.5 to 5 weight %.

11. An ink-jet recording medium according to claim 1, wherein soluble salts of boric acids are used.

12. An ink-jet recording medium according to claim 1, wherein the dry content of boric acid or a borate soluble salts in the solution is from 5 to 50 weight %, as calculated as H₃BO₃ relative to the polyvinyl alcohol.

13. An ink-jet recording medium according to claim 1, wherein said surfactant is selected from the group consisting of amphoteric surfactants, cationic surfactants, and nonionic surfactants.

14. An ink-jet recording medium according to claim 1, wherein said surfactants are nonionic surfactants.

15. An ink-jet recording medium according to claim 1, wherein said medium is obtained by using a slide coater system.

16. An ink-jet recording medium according to claim 15, wherein said medium obtained by a slide coater system is dried at a temperature lower than 60° C.

17. A method of forming an ink-jet recording medium having improved receptor layer coating quality comprising:
preparing a coating solution comprising alumina hydrate, polyvinyl alcohol with a saponification degree lower than 90%, boric acid or a borate, and at least a surfactant;
coating the coating solution onto a substrate; and
drying the coating solution.

18. The method of claim 17 wherein coating the solution onto a substrate is performed by slide coating or knife coating.

19. The method of claim 17 wherein coating the solution onto a substrate is performed by slide coating.

20. The method of claim 19 wherein the alumina hydrate has a boehmite or pseudo-boehmite structure of formula Al₂O₃.nH₂O, wherein n is a number from 1.0 to 2.0, the average particle diameter of the alumina hydrate is in the range from 10 to 200 nm, the dry content of boric acid or a borate soluble salts in the solution is from 5 to 50 weight %, as calculated as H₃BO₃ relative to the polyvinyl alcohol, and wherein the surfactants are selected from the group consisting of amphoteric surfactants, cationic surfactants, and nonionic surfactants.
